(19) United States
(12) Patent Application Publication
(10) Pub. No.: US 2014/0319726 A1
(43) Pub. Date: Oct. 30, 2014

(54) Maximum body security in non-horizontal burials

(71) Applicant: Donald E. Scruggs, Chino, CA (US)

(72) Inventor: Donald E. Scruggs, Chino, CA (US)

(21) Appl. No.: 13/986,390

(22) Filed: Apr. 26, 2013

(51) Int. Cl. A01N 1/02; A61G 17/06

(52) U.S. Cl. CPC A01N 1/0205; A61G 17/06
USPC 264/279.1

(57) ABSTRACT

A method whereby a body is fully protected and held securely in a dignified position in curing and setting material forming a capsule which can be interred non-horizontally directly into the ground or placed within a screw-in or self-digging type burial container for non-horizontal interment in ponds, near trees or in other unused small spaces in a cemetery.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

This invention relates to economically maximizing body security in a dignified position in a capsule alone or within burial containers to be interred in non-horizontal positions.

### BACKGROUND OF THE INVENTION

A Current practice for interring bodies is to dig a large hole in the ground and store the removed material for later covering the burial container and re-filling the hole. Currently the burial container is lowered into the large hole and the removed material is placed and tamped around and on the burial container. Ground covering is then placed over the top, to restore the original appearance of the area, and the surplus receiving material is removed. To save cemetery space and reduce the cost of labor an often practiced method is to set a casket into the ground in a vertical position. This practice causes the body to crumple into the foot end of the burial container, the thought of which usually stresses loved ones.

If a hole is dug in a high water table area, the hole soon fills with water. Such cases present a near impossible problem in digging a grave site. Screw-in or self digging burial containers solve the problem. They do not require large pre-dug holes, but can be simply screwed or bored into the usually damp ground and with the present invention the body remains in a dignified and upright position.

### OBJECTS OF THE INVENTION

It is an object of this invention to provide a means by which a body will be securely set in a burial container which is to be interred in a non-horizontal position and the body will not crumple to the foot end of the burial container.

### OPERATING PRINCIPALS AND PREFERRED EMBODIMENT

The preferred embodiment of this invention is to wrap a body with a flexible sheet material, place it into a release-surfaced mold, making certain that no part of the body or its wrapping touches the surface of the mold, and insert a curing and setting material around the body and wrapping. The curing and setting material firms up and makes a capsule which acts as a form fitting body tray and shroud. An expanding curing and setting foam is usually lighter in weight, more readily forms around the body and makes the burial container easier to handle during the transport and interment process. If the mold is made to the same shape and dimensions as the inside of a non-horizontal burial container the capsule will fit snugly into the burial container which will provide the overall strength for interment of a non-horizontal screw-in, self digging, self boring or reaming type container. Should the party responsible for the burial wish to take advantage of the most economical interment, such a capsule can be slipped directly into a non-horizontal hole without an enclosing burial container. If the body is later exhumed, the curing and setting material can be cut down to the flexible material wrapping and broken away, much like when a cast is removed from a broken limb.

### DESCRIPTION OF FIGURES

FIG. 1 is a cut-away side view of a body, 100, in a conventional coffin or casket, 101, for a regular funeral service.

FIG. 2 is a side view of a body, 103, as shown in FIG. 1, being lightly wrapped with flexible sheet wrapping material, 104.

FIG. 3 is a side view of a mold insert piece to form a shape, such as a hex, 106, which can be held and manipulated by a positioning and rotating device adapted to a cemetery vehicle, and an upper flange, 107, larger than the mold, to keep the insert piece on top of the mold, and a lower flange, 109, of the same diameter and shape as the inside of the mold to keep the curing and setting material in place.

FIG. 4 is a view looking up of the insert piece as shown in FIG. 3, pointing out the outside flange, 107, an inside hex shape, 106, and a lower flange, 109.

FIG. 5 is a cutaway view of a vertical mold, 112, shaped and dimensioned the same as the insides of a screw-in, self boring or self reaming non-horizontal burial container, with a body, 115, in place, an insert piece, 111, having an upper flange in place, a wheeled frame, 114, the now set up curing and setting material, 116, first placed into the mold, and the small peg-like braces, 117, to keep the body in position as the curing and setting material is inserted.

FIG. 6 is an orthographic view of an encapsulated body, 119, in a capsule, 120, of curing and setting material, showing its round cross section matching the shape and dimensions of a screw-in, self boring or self reaming non-horizontal burial container and pointing out the hex molded upper segment, 122, to be manipulated by a mechanical positioning device, and a grave marker, 123, locked into the curing and setting material.

FIG. 7 is an orthographic view of an upper section of an oblong cross section horizontal mold having holes, 125, for inserting a curing and setting material after a body is placed in the burial container, a grave marker is in place inside the relief, 128, and the upper and lower sections are fastened together by the flanges, 126.

FIG. 8 is an orthographic view of the lower section of an oblong cross section horizontal mold with a body, 130, laid on pre-inserted curing and setting material, 131, and showing its flange, 132, to match up and be fastened to the flange shown as item 126, in FIG. 7, and showing the relief space, 133, for the grave marker.

FIG. 9 is an orthographic view of a grave marker, 135, having knobs, 136, on shafts extending outward for holding the grave marker firmly into the curing and setting material.

FIG. 10 is an orthographic view of an assembled horizontal mold with holes, 125, into which a curing and setting material is inserted into the mold, to flow around the body in the mold, filling and encapsulating the body, and also showing the now fastened together flanges, 138, and the relief space, 139, in the mold for a grave marker.

FIG. 11 is an orthographic view of a finished, oval shaped, 144, capsule, 141, with a body, 142, sealed inside, and having an optional grave marker, 143, embedded.

FIG. 12 is a side view of a cemetery vehicle, 146, using a mechanical positioning device, 147, to inter a body encased capsule, 148, by itself, such as those shown in FIGS. 6 and 11, into a non-horizontal, nearly vertical, hole, 150.

FIG. 13 is a side view of a cemetery vehicle, 146, using a mechanical positioning device, 147, to inter a body encased capsule, 148, by itself, such as those shown in FIGS. 6 and 11, with a body inside, into a non-horizontal hole, 152, in a sloped embankment.

FIG. 14 is a view of a cemetery vehicle, 146, using a mechanical positioning device, 147, to inter a screw-in coffin, 154, with a body encased capsule inside, such as those shown in FIGS. 6 and 11, into a pond, 155. Note the self boring burial container, 158, already in place in the pond.

FIG. 15 is a view of a screw-in coffin, 162, with a body encased capsule, such as those shown in FIGS. 6 and 11, inside, interred non-horizontally between the roots, 161, of a tree, 160, without damaging the root structure of the tree.

FIG. 16 is a view of a screw-in coffin, 164, with a body encased capsule inside, such as those shown in FIGS. 6 and 11, interred non-horizontally close to the curbing, 168, of a roadway, 166.

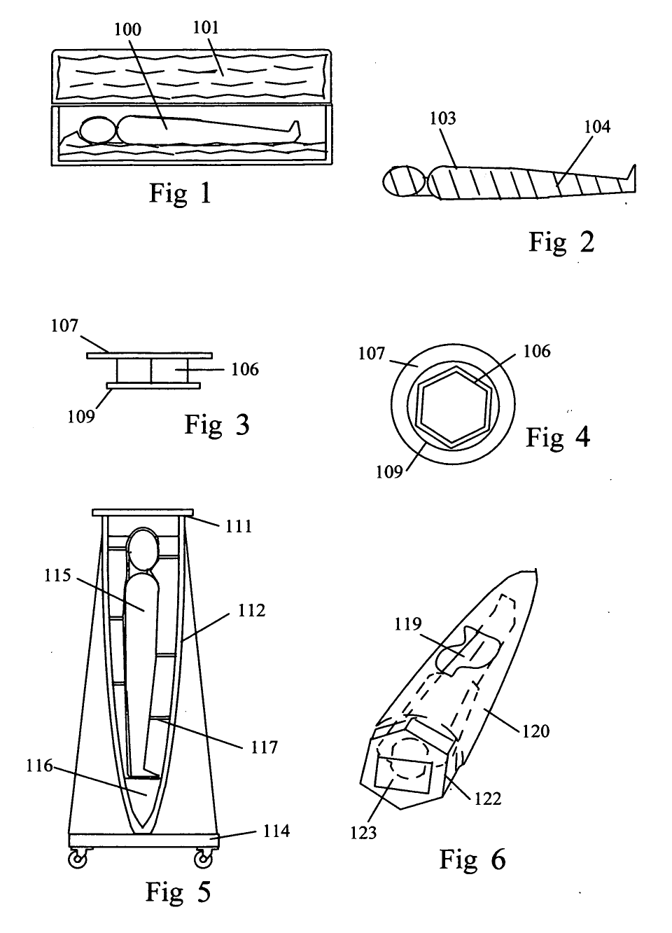

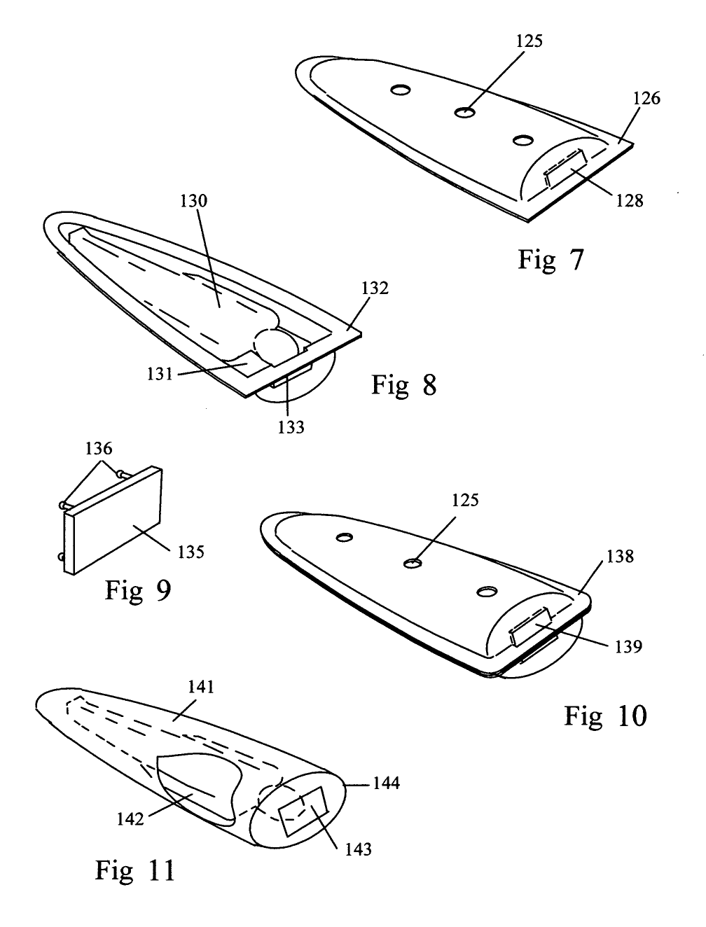

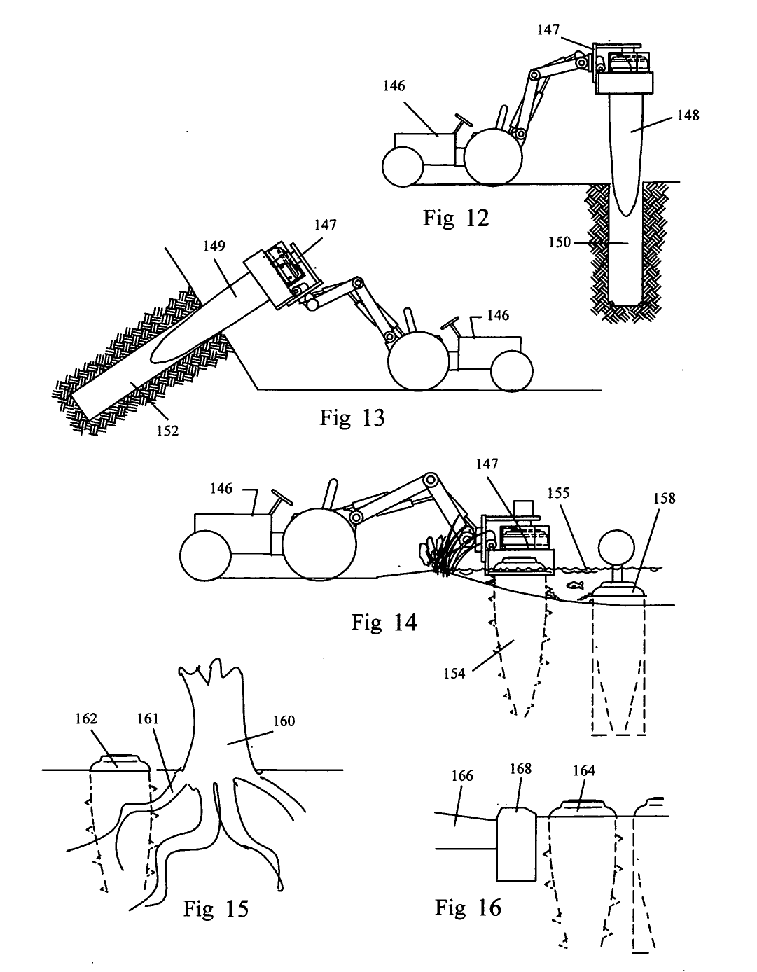

I claim:

1. A method whereby a body is placed into a mold and a curing material is inserted entirely around the body between the body and the inside surfaces of the mold.

2. A method as in claim 1, where spacing members are used to hold the body away from the inside surfaces of the mold.

3. A method as in claim 1, where an amount of a curing material is inserted into the mold and allowed to set up to form a platform for the body before the body is placed into the mold.

4. A method as in claim 1, where a body is wrapped in a flexible material before it is placed into a mold.

5. A method whereby a body is wrapped in a flexible material and placed into a mold and a curing material is inserted entirely around the wrapped body between the wrapped body and the inside surfaces of the mold.

6. A method whereby a capsule is produced by placing a body in a mold having the same internal dimensions as the inside dimensions of a burial container into which the capsule is to be placed, and a curing material is inserted entirely around the body between the body and the inside surfaces of the mold.

7. A method as in claim 6, where the capsule has a grave marker embedded in the curing material.
